(19) United States
(12) Patent Application Publication
(10) Pub. No.: US 2025/0383256 A1
(43) Pub. Date: Dec. 18, 2025

(54) ULTRASONIC INSPECTION DEVICE FOR IN-SERVICE STORAGE TANKS

(71) Applicant: FH Barn, Fair Haven, NJ (US)

(72) Inventor: Kelan McElduff, Fair Haven, NJ (US)

(73) Assignee: FH Barn, Fair Haven, NJ (US)

(21) Appl. No.: 18/741,199

(22) Filed: Jun. 12, 2024

(51) Int. Cl. G01M 3/24; G01N 29/265; G01N 29/32; G05D 1/648

(52) U.S. Cl. CPC G01M 3/24; G01N 29/265; G01N 29/32; G05D 1/6484; G01N 2291/2636

(57) ABSTRACT

Some embodiments comprise a vehicle for conducting non-destructive evaluation (NDE) tests of storage tanks, especially storage tank bottoms. Vehicles may be autonomous, semi-autonomous, or manually driven ROVs. At least one NDE instrument probe is onboard as well as at least one high and/or low-pressure fluid nozzle which is either repositionable or fixed on an area in front of the NDE probe. Thus, as the vehicle advances, the nozzle cleans a path in front of the probe to improve the probe's coupling to the tank bottom. Repositionable nozzles may be motorized and under computer control. The nozzle receives fluid flow from a pump configured in recirculation mode. Thus, the pump draws in tank fluid and outputs a high or low-pressure high-volume stream to the nozzle, which directs the flow.

### I. BACKGROUND OF THE INVENTION

### A. Field of Invention

The invention generally relates to the field of nondestructive testing of in-service, and out of service, storage tanks.

### B. Description of the Related Art

Aboveground storage tanks are widely used in the petroleum and chemical industries for storing various liquids including crude oil and chemical feed stocks. State and federal Spill Prevention Control and Countermeasures regulations require testing of such tanks. For example, 40 C.F.R. 112.8(c)(6) requires operators of aboveground tanks to “test or inspect each aboveground container for integrity on a regular schedule”. The regulation names ultrasonic testing as an example of an acceptable integrity test. Tank walls can be tested from the exterior; however, tank bottoms are inaccessible from anywhere but inside the tank. Therefore, early integrity testing methods required the tank operator to empty the tank periodically, taking it out of service. This has a clear cost disadvantage because such tanks are costly, and an empty tank is not generating revenue. Remotely operated vehicles (ROVs) have been introduced for conducting nondestructive testing of tank bottoms. Known ROVs are generally tracked vehicles that ultrasonically scan the tank bottom looking for cracks, fissures, and corrosion that may lead to failure.

It is well-known that crude oil is a mix of organic and inorganic matter including water, clays, and soil, and a wide range of hydrocarbons from very small volatile molecules, to oils of various molecular weights, and solids like paraffinic waxes. When crude oil is first collected from a well it goes through various stages of cleaning to remove unwanted materials. It may contain a large amount of water and mud pumped out of the well along with the crude oil, so a primary gravity separation is often used remove much of the easily separated mud through gravity alone. This may be followed by a free water knockout to remove much of the unemulsified water. The crude may then undergo desanding or desilting processes. Degassing methods may be applied to reduce the level of dissolved toxic or corrosive gasses like H₂S. Nonetheless, even after initial cleaning steps the crude oil remains a complex mix of emulsified water, and organic and inorganic materials. Prior to transportation through pipelines the crude is often stored in large storage tanks to undergo further separation. Consequently, the inside of a crude oil tank is a very dirty environment typically including corrosive chemicals. In the event that such a tank fails, it would result in enormous environmental damage and financial loss to the operator. Accordingly, regular inspections are not only mandated by law, the operator has a clear economic motivation to ensure its tanks are in good working order.

Storage tanks generally contain a top layer of organic matter including gases, oils, and waxes, as well as entrained inorganic particulates of mud and clay. Demulsifying water, separating from the organic layer, forms a bottom layer. Inspection devices occupy the aqueous environment at the tank bottom. Measurements, like ultrasonic testing, require good contact between the test probe and the test surface. However, the test surface is often obstructed because the water contains large amounts of sediments. Some sediment is inorganic matter that cannot be resuspended. But, a large portion of the sediment is paraffinic sludge and/or asphaltic sludge that has economic value, and could be resuspended in the organic layer.

Existing devices apply various means for temporarily moving sediments out of the way of a test probe. For instance, it is known to use plow-like devices and brushes for this purpose, but these methods have certain drawbacks. Plows and brushes both do an incomplete job of cleaning a test surface, and their motion tends to stir up sediment clouds, which may complicate measurements. Furthermore, this method fails to address paraffinic sludge, which will remain sedimented.

It is known to use pumps to resuspend paraffinic sludges by applying shear forces to sediments. For instance, it is known to station such a pump in the center of a tank, allowing it to rotate under the thrust of its own output. Alternatively, it is known to place such pumps around the perimeter of a tank. In either case, the pumps generally have blind spots where the jets cannot reach, leaving sedimented paraffinic sludge in those areas.

Some embodiments of the present invention may provide one or more benefits or advantages over the prior art.

### II. SUMMARY OF THE INVENTION

Some embodiments comprise a tank inspection device. The tank inspection device may comprise a vehicle having a frame supporting a mobility system, and comprising a navigation system, a nondestructive test probe, one or more fluid nozzles, and a control system. The mobility system may comprise a running gear in driving communication with a motor through a transmission. The control system is in controlling communication with the motor, the running gear, the fluid nozzle, and the nondestructive test probe. The control system is also in electronic data communication with the navigation system. The navigation system is configured to cause the control system to drive the mobility system at a prescribed velocity.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1A is a drawing of an autonomous embodiment;

FIG. 1B-1 is a drawing of the vehicle portion a remotely operated vehicle embodiment;

FIG. 1B-2 is a drawing of the off-board controls of the remotely operated embodiment of FIG. 1B-1;

FIG. 1B-3 is a drawing of a shroud housing an NDE probe and nozzle;

FIG. 2A is a view of the nozzle taken along line 2-2 in FIG. 1B-1 showing a 0-90° pitch (θ) range of motion;

FIG. 2B is a view of the nozzle taken along line 2-2 in FIG. 1B-1 showing a 0-180° yaw (v) range of motion;

FIG. 2C is a view of the nozzle taken along line 2-2 in FIG. 1B-1 showing an oblique pitch (θ) between 0° and 90 swiveling through a 0-180° yaw (ψ) range of motion;

FIG. 3A is a plan view drawing of a first off-board pump configuration in recirculation mode;

FIG. 3B is a plan view drawing of a second off-board pump configuration in recirculation mode;

FIG. 3C is a plan view drawing of a third off-board pump configuration where the pump draws from a secondary tank; and

FIG. 4 is a plan view illustration of a drive path having waypoints.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

The term umbilical is used here to refer generally to any input line or lines connecting to the vehicle from an external source. The term umbilical is also used herein to describe structures that bundle various input line which may include one or more of power lines, data lines, control lines, or fluid lines. According to some embodiments, an umbilical can even be a simple tether containing no inputs. Such a tether may be used to retrieve the vehicle in the event of a failure condition.

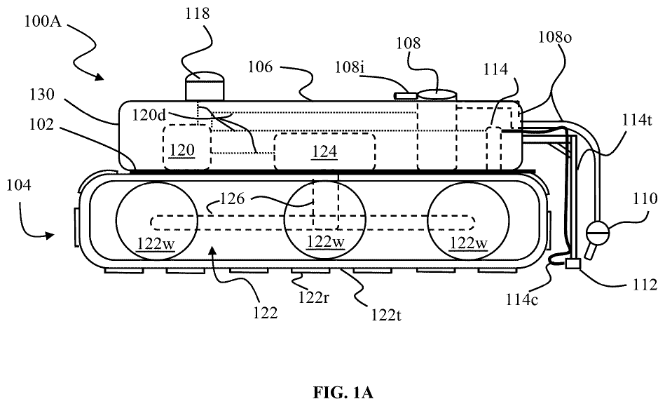

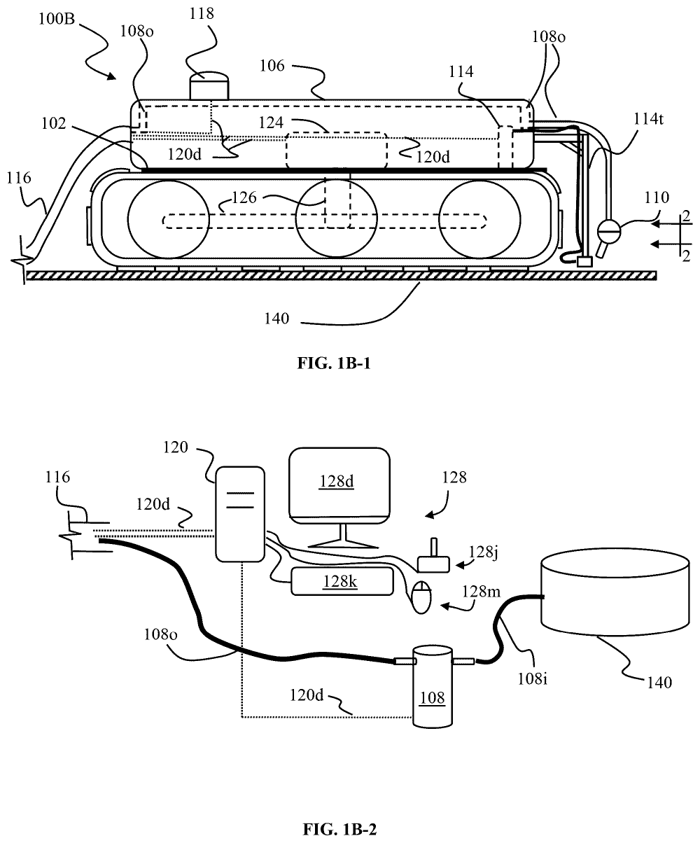

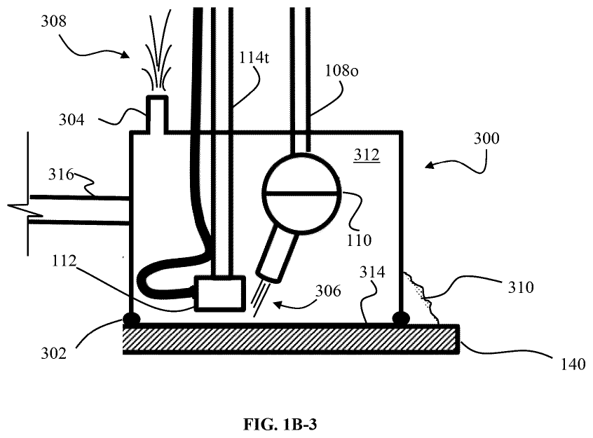

Referring now to the drawings wherein the showings are for purposes of illustrating embodiments of the invention only and not for purposes of limiting the same, FIG. 1A is a drawing of an autonomous embodiment 100A of the invention. The embodiment 100A is a tracked vehicle having a mobility system 104 comprising a running gear 122 with continuous tracks 122t. The tracks 122t of this embodiment are rubberized and have rubber treads 122r. Other embodiments may comprise metal tracks with rubber treads or metal treads. Some embodiments may even include ferromagnetic inserts in the treads to aid in maintaining a fixed position, or to aid in gaining traction. The running gear 122 is driven by a motor 124 through a transmission 126. The person having ordinary skill will be readily capable of selecting and integrating known motor, transmission and running gear components without undue experimentation.

With continuing reference to FIG. 1A, the motor 124 is mounted on a frame 102 which also supports the mobility system 104 and a body 130. The body 130 may be used to house and/or mount other components to the embodiment 100A such as a control system 120, a pump 108, a non-destructive evaluation (NDE) device 114, and a navigation system 118. The body 130 may optionally comprise an enclosure, but an enclosure is not a requirement of the invention. In some embodiments it is enough to provide a platform or scaffold for mounting subsystems, and routing fluid lines, data and control lines, and power lines. The body may be an integral part of or extension of the frame. The frame 102 and body 130 may take on a wide variety of configurations without departing from the scope of the invention. Such configurations will be selected by the person of ordinary skill as a matter of design choice.

In the illustrated embodiment, an onboard control system 120 is included to provide control over other systems, to store data received from systems like the navigation system 118 and NDE system 114, and to provide data processing capabilities. The control system 120 sends and receives control signals and data through lines 120d. As used herein, all electrical lines are denoted 120d regardless of whether they are power lines, control lines, or data lines or a combination thereof. Control systems 120 can be configured according to many well-known schemes provided that they perform the functions discussed herein.

Optionally, control systems 120 may also distribute power from the motor 124 to other components such as the navigation system 118 and the NDE system 114 thereby controlling their on and off states e.g. through software, or power may be supplied to one or more subsystems directly from the motor 124 without requiring distribution by the control system 120. Alternatively, or additionally, the control system 120 may issue control signals and/or electronic instructions to control the on and off states of such subsystems regardless of whether power is distributed through the control system 120 or directly from the motor 124. This embodiment 100A being autonomous, the control system 120 includes suitable programming to navigate a tank bottom and collect NDE data without human intervention. The human user need only set up the device and place it within a tank, allow it to operate, and then retrieve the device. In some embodiments NDE data can be read from the vehicle after retrieval. Alternatively, or additionally, embodiments may communicate data acoustically according to know acoustic data transmission methodologies, or optically through e.g. a Li-Fi system. Such embodiments may have a receiver or transceiver 150 inside the tank 140 that electronically communicates the data to a computer 120 external to the tank 140.

The motor may draw power from conventional sources. Some embodiments utilize conventional lithium ion battery packs for this purpose. Various other well-known battery or fuel cell technologies may be used, as a matter of design choice, to power embodiments of the invention. In general, suitable power sources are compatible with explosion-proof design and are capable of operating in a closed system. As shown in FIG. 1A, the motor 124 and power source are shown as a single undifferentiated structure. In practice, the motor and power source may be separate structures in electrical communication with each other and/or with the control system 120.

The control system 120 may also control a motor 124, causing it to start and stop driving one or both tracks of the running gear 122. The motor 124 is shown in FIGS. 1A and 1B-1 above the running gear 122; however, this is not a requirement of the invention. The motor may be placed between the tracks or in the body 130 as a matter of design choice. In part, space limitations and transmission 126 design may dictate placement of the motor 124. The transmission 126 of FIGS. 1A and 1B-1 is shown schematically in two logical parts, and is not intended to reflect an actual physical form or placement of parts. Rather it merely indicates that in this embodiment power is transferred downward from the motor and distributed horizontally to the wheels 122w of the running gear 122. The person having ordinary skill will readily understand that in embodiments where the motor's power transfer components are on the same plane as that of the transmission, no downward component of the transmission 126 would be necessary.

In some embodiments the NDE subsystem 114 is in electronic data communication and electronic control communication with a probe 112 through a cable 114c. The probe 112 may be mounted to a truss 114t. The truss 114t may be static or it may be motorized e.g., under the control of the control system 120. For instance, a motorized truss 114t may have a vertical range of motion suitable for lifting and lowering the probe 112. Such a truss may have additional degrees of freedom to its range of motion as a matter of design choice. The person having ordinary skill will readily understand how to construct a static or motorized truss from known parts using conventional methodologies.

With reference to FIG. 1B-3, embodiments may surround the NDE probe 112 with a boot or shroud 300. The shroud 300 is a rigid covering or a stiff rubber covering that excludes sludge 310 from the shroud's interior 312. A nozzle 110 operating at high-pressure, e.g. above 2500 psig, directs a flow 306 of fluid onto the test surface 314. The pressure of the nozzle (110) and fluid stream 306 are directed to a position adjacent to the test probe, where the pressure of the stream is sufficient to remove adherent sludge or mineral deposits from the surface 314. The shroud 300 includes a fluid vent 308 that allows the pressure inside the shroud to equalize with the external volume. The shroud may also include a rubber seal 302 that contacts the tank bottom 140, and thereby assists in excluding sludge 310 from the interior. Although the rubber seal illustrated in FIG. 1B-3 is shown in cross section, it extends around the entire perimeter of the shroud. While the means by which the shroud is attached to the embodiment is not illustrated, the person having ordinary skill will readily understand how to integrate a shroud according to well-known structures and methodologies. For instance, in one non-limiting example, a shroud is fixed to the truss 114t and/or output line 1080 e.g., by welding, fastening, or other known means. Lateral bracing may be added as needed, for instance, by connecting the shroud 300 to the vehicle frame through a horizontal member 316. Where lateral bracing is used, the shroud may receive the truss 114t, the fluid line 1080 and other inputs through openings sealed by e.g., rubber grommets or similar structures.

The NDE component 114 may be in controlling communication and data communication with a control system 120 through electrical lines 120d. The control system may issue control signals and/or electronic instructions to the NDE device 114 causing it to power on or off, and to start or stop collecting data. In some embodiments data is stored in a buffer memory in the device 114 and transferred through known bus architectures to the control system 120. However, this is not a requirement of the invention. As a matter of design choice the person having ordinary skill may write data directly to a memory located in the control unit or any other convenient location according to know methods.

NDE components according to the invention may include one or more of an ultrasonic test probe, a phased array ultrasonic test probe, a radiographic test probe, or an acoustic emissions test probe. Any conventional NDE device known to be useful for measuring the thickness of metal plates and/or detecting cracks, fissures, or other defects in metal plates, is within the scope of the invention. Ultrasonic probes within the scope of the invention include contact probes having a straight beam. Known beam focusing methodologies may be employed where the application demands greater resolution. Where higher resolution is warranted, embodiments may include phased array type ultrasonic probes to enable scanning the probe's focal point through a range of depths. A person having ordinary skill in the art will be readily capable of selecting and integrating an NDE device, or a combination of NDE devices, in an embodiment without undue experimentation.

Embodiments move the NDE probe along the tank bottom to collect A-Scan data at a series of positions, and assemble the A-Scans into B-Scans. Knowing the position at which each A-Scan was acquired allows the embodiment to construct B-Scans that represent a to-scale map of the tank bottom showing its thickness throughout the tank bottom's entire extent, and mapping the position of defects. Position may be determined by the navigation system 118 and may be co-registered with NDE data. For example, the control system 120 may receive time series data feeds from the navigation system 118 and from the NDE system 114. Accordingly, the control system can be suitably programmed to identify the position at which each NDE data point was collected, thereby co-registering the data feeds.

The navigation system can be comprised of a variety of known locating technologies including, without limitation, one or more of sonic ranging, laser ranging, accelerometers, electromechanical gyroscopic sensors, or other echo or inertial navigation equipment. Embodiments may use ranging devices to compile a map of a tank to be analyzed and determine its position on the map. Position may be updated at a predetermined frequency, tracking the position of the vehicle with sufficient time resolution to avoid aliasing the corresponding NDE A-Scan data. The person having ordinary skill will readily understand how to adjust position measurement frequency, vehicle speed, and NDE data acquisition rate to avoid aliasing.

The navigation system of the illustrated, autonomous, embodiment 100A is also used to autonomously navigate the tank 140 bottom. Autonomous embodiments are suitably programed to drive the vehicle along a predetermined path, permitting NDE measurements of the entire extent of the tank bottom. Persons having ordinary skill will be readily capable of programming embodiments to compile a map of the tank upon startup, and plan a route through which the vehicle will travel to scan the full tank bottom. Such routes may be comprised of waypoints. For example, an autonomous embodiment may use way points to compile a set of instructions comprising a drive program, whereby the control system 120 issues control signals and/or electronic instructions to the mobility system 104 causing the vehicle to move to each waypoint comprising a route or drive program. In some embodiments a map may be preloaded and may include waypoints. In such embodiments, the vehicle may use the navigation system to determine when each waypoint has been reached.

Embodiments include a fluid nozzle 110 configured in recirculation mode to deliver high flows of recirculated tank fluid in directed streams. Nozzles according to the invention may be statically set to direct fluid jets on a selected location relative to the vehicle. Thus, as the vehicle moves, the fluid jet moves. This may be sufficient where the nozzle's function is primarily to prepare a spot immediately in front of the NDE probe for testing. In continuous operation, as the vehicle advances the nozzle 110 cleans a trail on the tank bottom, and the NDE probe proceeds immediately behind it.

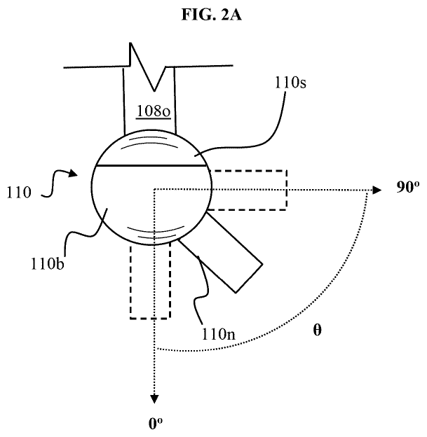

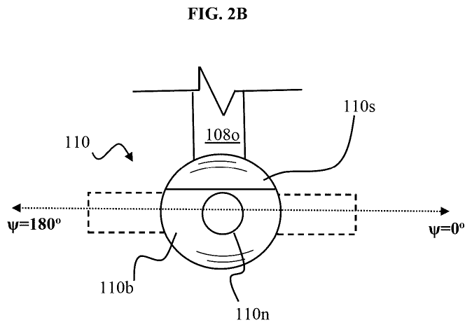

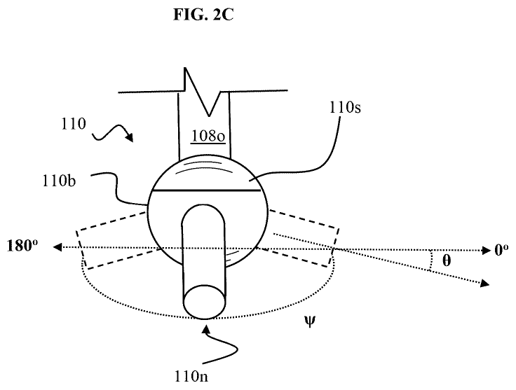

In other embodiments, such as that of FIGS. 2A, 2B and 2C, the nozzle 110 is movable and may be motorized and under the control of the control system 120. Embodiments may have any suitable range of motion such as, without limitation, a 0-120° yaw range of motion at a fixed 45° pitch directed aft of the vehicle, as shown in FIGS. 1A and 1B-1. With reference to FIGS. 2A, 2B, and 2C, the illustrated embodiment has a nozzle on a ball and socket joint providing two degrees of freedom in pitch θ and yaw ψ. In the illustrated embodiment, pitch can be adjusted continuously from 0° to 90° (FIG. 2A). Likewise, in the illustrated embodiment, yaw can be adjusted continuously between 0° and 180° (FIG. 2B). FIG. 2C shows an intermediate position where pitch (θ) is in an oblique position and yaw (ψ) is at about 90°. A repositionable nozzle 110 may be particularly advantageous where the NDE probe is also moveable, rather than being in a fixed position relative to the vehicle and/or test probe 112. Additionally, a repositionable nozzle may useful for resuspending sediments that would otherwise not be reached by a nozzle directed solely for prepare NDE test surfaces.

Some embodiments may even have a plurality of nozzles, where one is dedicated to preparing NDE test surfaces and one or more others are dedicated to resuspending sediments. According to such embodiments, a nozzle dedicated to resuspending sediments is a lower pressure, higher flow, nozzle typically operating under 500 psig, and more specifically between 250 psig and 325 psig. Such nozzles further operate in a flow range from 275 to 350 gallons per minute. Generally, the operating pressure and flow is determined, in part, by the nozzle's orifice. A larger diameter and shorter length orifice will naturally produce a lower pressure and higher flow than another nozzle having a smaller diameter and longer orifice. The pump driving flow also has a significant effect on pressure and flow; however, embodiments may use a single pump operating at the same power level to drive a low pressure nozzle and a high pressure nozzle. Accordingly, pressure and flow are more or less determined by orifice diameter and length.

The nozzle receives high pressure fluid through line 1080, which is the output line of pump 108. The fluid is drawn from the tank 140 through intake 108i (FIGS. 1A and 1B-1). The delivery pressure at the nozzle output 110n is between 250 psig and 325 psig, and the flow rate is between 275 and 350 gallons per minute (gpm). These ranges of pressure and flow are known to provide sufficient energy input to shear flocculated paraffinic sediments, forming a stable suspension. Suitable pumps are commercially available, and their selection and integration are well within the skill in the art. One example of a suitable pump is the FF-3A-SM by Fast Flow Pumps.

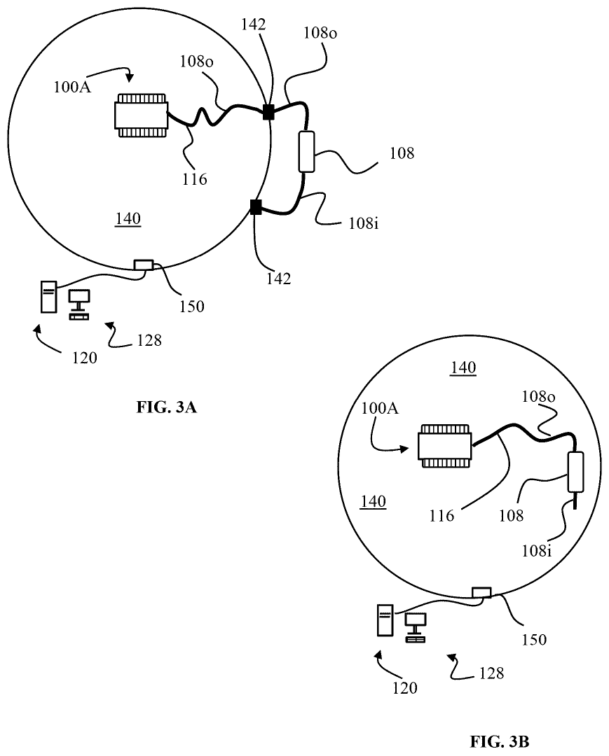

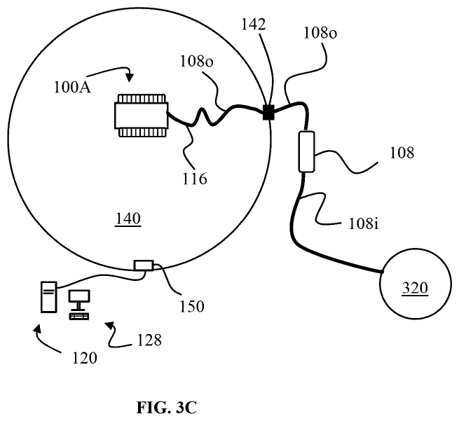

In the illustrated embodiment the pump 108 is mounted to the body 130 and/or frame 102. However, autonomous embodiments of the invention are not limited to onboard pumps. Rather, a pump may be located off-board either outside or inside the tank 140. FIG. 3A shows an autonomous embodiment 100A where the pump 108 is located external to the tank 140. An intake line 108i couples to the tank wall through a bulkhead fitting 142 putting the pump 108 in fluid communication with the interior of the tank 140. The output line 1080 of the pump 108 connects back to the tank 140 through a second bulkhead fitting 142. A second section of the output line 1080 connects to the vehicle 100A as an umbilical 116. In FIG. 3B an alternative recirculation mode is provided showing the pump 108 off-board but inside the tank 140. No bulkheads are necessary. Instead, the intake line 108i draws in fluid from the region immediately surrounding the pump 108 and the output line 1080 delivers a flow of pressurized fluid to the vehicle 100A as an umbilical 116. In FIG. 3C, the pump 108 draws fluid from a second tank 320, and delivers the fluid through an output line 1080 and bulkhead fitting 142 to an embodiment 100A. The second tank 320 may contain, for example, water, liquid hydrocarbon, or pretreated hot diesel, for the purpose of resuspending sludges. The off-board pump configurations described in relation to FIGS. 3A, 3B and 3C are not limited to autonomous embodiments, and may comprise elements of a remotely operated vehicle (ROV) embodiment, as described in more detail elsewhere herein.

Turning to FIGS. 1B-1 and 1B-2, a remote operated vehicle (ROV) embodiment 100B is shown. In this embodiment an umbilical 116 is provided to supply one or more resources such as power, fluid flow, and off-board control of the various onboard systems like the NDE system 114 and the mobility system 104. The umbilical 116 may also include data lines through which the onboard systems, such as NDE 114 or navigation system 118, communicate data to a remote computing resource for processing and/or storage. For example, the control system 120 may be remote, and may connect to the vehicle 100B through control and data lines 120d routed through the umbilical 116. The control system 120 may process time series data streams from the navigation system 118 and the NDE system 114, co-registering them and generating A-Scans and B-Scans from the data.

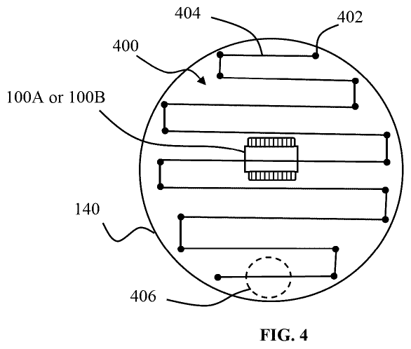

With reference to FIG. 1B-2 an off-board control system 120 may have various user interface peripherals 128 such as a display screen 128d, keyboard 128k, mouse 128m, joystick 128j, trackball, or any other well-known user interface device. The user may avail themselves of user interface hardware and software to control the vehicle 100B. For instance, in one embodiment 100B the navigation system 118 determines the vehicle's position on a map of the tank 140 and the user interface 128 displays the vehicle's real time position such as shown in FIG. 4. The user may insert the vehicle at an access port such as the roof access port 406 shown in FIG. 4. Then the user can drive the vehicle through a path 400 covering the entire extent of the tank bottom, and drive back to the access port where the vehicle can be recovered. With regard to FIG. 4, the intention is to illustrate navigation in general without limiting the illustration to a particular embodiment. Thus, the vehicle is designated as “100A or 100B”, even though no umbilical is illustrated.

Some embodiments may optionally include a drive-by-wire feature whereby the user is limited to making gross control decisions such as when and in what direction the vehicle is to move. For instance, a user interface command issued through a joy stick may be interpreted by the control system 120 simply as an instruction move forward or backward, or to execute a U-turn to the left or right. Based on a stored map of the tank, data from the navigation system 118, and a computed path 400, including waypoints 402 and drive distances 404, the control system 120 may determine the right combination of mobility system control commands to execute the user instruction. Further, the embodiment may use navigation system data to correct its heading to the extent that the vehicle deviates from a planned path 400. Embodiments may further limit the user to intervening only at waypoints 402. For instance, the embodiment may drive autonomously to a waypoint and then wait for the next user instruction. In such embodiments, a joystick may be unnecessary. Instead, user-level navigation control may be accomplished with a keyboard e.g., the up-down-left-right arrows or even just the spacebar alone to step through a planned path.

A user may also control the NDE system 114, determining when data acquisition starts and stop. In embodiments where the nozzle 110 is articulated and motorized, the nozzle 110 may also be under user control. Accordingly, through the interface, the user may sweep the nozzle 110 from side to side or otherwise reposition the nozzle as desired. This functionality may provide a means for more thoroughly resuspending flocculated paraffins comprising the sludge that would otherwise cover the tank bottom.

In some embodiments, data and control signals are communicated to and from the vehicle through the umbilical 116. In other embodiments, the tank may include a receiver 150, such as an acoustic transducer, adapted to receive acoustic data signals communicated from the vehicle. Some embodiments may include a transceiver 150, such as an acoustic transceiver, for sending and receiving signals, which may include data and control signals to and from the vehicle. Acoustic data transmission rates are known to be relatively slow due to the much slower wave speed of sonic signals in (1.5×10³ m/s) versus electromagnetic signals (3×10⁸ m/s). In other embodiments, known Li-Fi communications may be integrated using fast switching LEDs to transmit diffuse photonic signals without need of a waveguide. The person having ordinary skill will understand how to integrate known sonic and/or Li-Fi communications and control systems for the purpose of remotely controlling an embodiment vehicle, including its various subsystems, and receiving navigation and/or NDE data from the vehicle in real time.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I claim:

1. A tank inspection device, comprising:
a vehicle comprising a frame (102) supporting a mobility system (104), and comprising a navigation system (118), a nondestructive test probe (112), at least one nozzle (110), and a control system (120);
the mobility system (104) comprising a running gear (122) in driving communication with a motor (124) through a transmission (126);
the control system (120) being in controlling communication with the motor (120), the running gear (122), the nozzle (110), and the nondestructive test probe (112), wherein the control system (120) is in electronic data communication with the navigation system (118); and
the navigation system (118) being configured to cause the control system (120) to drive the mobility system (104) at a prescribed velocity.

2. The tank inspection device of claim 1, wherein the running gear comprises continuous tracks (122t) having treads (122r), wherein the treads comprise one or more of rubber, metal, or ferromagnetic material.

3. The tank inspection device of claim 1, wherein the nondestructive test probe is selected from one or more of an ultrasonic test probe, an ultrasonic phased array probe, a radiographic test probe, or an acoustic emissions test probe.

4. The tank inspection device of claim 1, wherein the at least one nozzle (110) is an articulated nozzle adapted to sweep through 0 to 180 degrees of yaw.

5. The tank inspection device of claim 1, wherein the at least one nozzle (110) is an articulated nozzle adapted to sweep through 0 to 90 degrees of pitch.

6. The tank inspection device of claim 1, wherein the at least one nozzle (110) is in fluid communication with an output (1080) of a pump (108).

7. The tank inspection device of claim 6, further comprising a pump (108) configured to operate in recirculation mode.

8. The tank inspection device of claim 6, wherein the pump (108) and the at least one nozzle (110) are configured to deliver fluid at a pressure from 250 to 3500 psig.

9. The tank inspection device of claim 8, wherein the pump (108) and the at least one nozzle (110) are configured to deliver fluid at a pressure from 250 to 500 psig, 500 to 1000 psig, 1000 to 1500 psig, 1500 to 2000 psig, 2000 to 2500 psig, 2500 to 3000 psig, or 3000 to 3500 psig.

10. The tank inspection device of claim 8, wherein the pump (108) and the at least one nozzle (110) are configured to deliver fluid at a pressure from 250 to 325 psig and at a flow rate from 275 to 350 gpm.

11. The tank inspection device of claim 6, wherein one or more of the pump (108), the control system (120), or the navigation system (118) is onboard the tank inspection device.

12. The tank inspection device of claim 11, wherein the navigation system (118) is onboard the tank inspection device and comprises a ranging device in data communication with the control system.

13. The tank inspection device of claim 6, wherein one or more of the pump (108), the control system (120), or the navigation system (118) is off-board the tank inspection device.

14. The tank inspection device of claim 13, wherein one or more of the pump (108), the control system (120), or the navigation system (118) communicates with onboard components of the tank inspection device through an umbilical (116).

15. The tank inspection device of claim 14, wherein the navigation system (118) comprises a user interface in electronic communication with the control system (120), the user interface being adapted to receive user inputs corresponding to mobility system (104) control commands.

16. The tank inspection device of claim 15, wherein the user interface comprises a display screen adapted to display a current position of the tank inspection device and a user input device selected from one or more of a joystick, a steering wheel, a mouse, or a keyboard.

17. The tank inspection device of claim 1, wherein the at least one nozzle (110) comprises a first nozzle (110) in a fixed position relative the test probe (112) and configured to operate at a pressure between 2500 psig and 3500 psig, and a second nozzle (110), wherein the second nozzle is articulated and configured to operate at a pressure between 250 psig and 500 psig.

18. The tank inspection device of claim 17, wherein the first nozzle (110) and the test probe (112) are enclosed in a shroud (300).

19. The tank inspection device of claim 18, wherein the shroud (330) is equipped with a rubber seal (302) around a bottom perimeter of the shroud.

20. The tank inspection device of claim 19, wherein the first nozzle (110) is directed to a position adjacent to the test probe.
